(19) United States
(12) Patent Application Publication
(10) Pub. No.: US 2025/0115526 A1
(43) Pub. Date: Apr. 10, 2025

(54) PROCESS FOR PRODUCING TOPSOIL AND COMPOST AND TOPSOIL AND COMPOST PRODUCTS

(71) Applicant: Airwareness, LLC, Statesville, NC (US)

(72) Inventor: Bart Abernathy, Statesville, NC (US)

(21) Appl. No.: 18/989,180

(22) Filed: Dec. 20, 2024

Related U.S. Application Data
(62) Division of application No. 17/498,824, filed on Oct. 12, 2021.

(51) Int. Cl. C05F 3/00; C05F 5/00; C05F 17/00

(52) U.S. Cl. CPC C05F 3/00; C05F 5/002; C05F 17/00

(57) ABSTRACT

A process for producing compost that includes the steps of providing a supply of vegetable matter selected from the group of vegetable matter consisting of trees, stumps, brush, leaves and animal manure, agitating the vegetable matter to loosen and remove dirt associated with the vegetable matter and reducing the size of the vegetable matter. A variable amount of the vegetable matter is incinerated to produce a fine ash and the vegetable matter is combined with the ash. A process for producing topsoil includes the step of adding dirt to the vegetable matter/ash combination. Compost and topsoil products are also disclosed.

### TECHNICAL FIELD AND BACKGROUND OF THE INVENTION

This invention relates generally to a process for producing topsoil and compost from tree stumps, limbs, brush and similar vegetative matter and the resulting topsoil and compost products. For purposes of this application, animal manure, such as horse manure, is considered vegetable matter since it is principally composed of undigested and partially digested grasses and grains. In many instances, the vegetative matter may be the result of towns and municipalities gathering such materials for disposal. Other sources of this waste material is at construction and grading sites, landscaping projects, lot clearings and the like. It is presently typical to simply dispose of these materials by delivering them to a landfill, where the materials are dumped for eventual decomposition. This practice is wasteful on several levels. First, these materials in their original form are heavy, bulky and take up an inordinate amount of space in landfills that could otherwise be used for disposal of materials more suited for landfill disposal. Second, these vegetative materials have a very high percentage of organic matter, which is particularly appropriate for reuse if processed into a suitable form. Third, even if these materials are incinerated to reduce their volume, lack of recycling simply means that the vast majority of the vegetative material goes “up in smoke” and results in both waste and pollution.

Therefore, there is a need for an efficient and cost-effective process of producing usable topsoil or compost from raw vegetative matter such as tree stumps, limbs, brush and similar vegetative matter.

There is also a need for a process of producing usable topsoil or compost from raw vegetative matter in order to save landfill space, generate revenue, reduce waste and pollution.

### SUMMARY OF THE INVENTION

In accordance with one aspect of the invention, a process for producing compost is provided and includes the steps of providing a supply of vegetable matter selected from the group of vegetable matter consisting of trees, stumps, brush, leaves and animal manure, agitating the vegetable matter to loosen and remove dirt associated with the vegetable matter, reducing the size of the vegetable matter, incinerating a variable amount of the vegetable matter to produce a fine ash, and combining the reduced-size vegetable matter and ash.

According to another aspect of the invention, the process includes the step of screening the combined reduced-size vegetable matter and ash to remove large debris.

According to another aspect of the invention, the process includes the step of at least partially decomposing the reduced size vegetable matter.

According to another aspect of the invention, the process includes the step of at least partially decomposing the reduced size vegetable matter before combining with the ash.

According to another aspect of the invention, the process includes the step of reducing the size of the vegetable matter comprises processing the vegetable matter through a chipper.

According to another aspect of the invention, a process for producing compost includes the steps of providing a supply of vegetable matter selected from the group of vegetable matter consisting of trees, stumps, brush, leaves and animal manure, agitating the vegetable matter to loosen and remove dirt associated with the vegetable matter, reducing the size of the vegetable matter, incinerating a variable amount of the vegetable matter to produce a fine ash, and combining the reduced-size vegetable matter, dirt and ash.

According to another aspect of the invention, the process includes the step of screening the combined reduced-size vegetable matter and ash to remove large debris.

According to another aspect of the invention, the process includes the step of at least partially decomposing the reduced size vegetable matter.

According to another aspect of the invention, the process includes the step of at least partially decomposing the reduced size vegetable matter before combining with the ash.

According to another aspect of the invention, the process includes the step of processing the vegetable matter through a chipper.

According to another aspect of the invention, the step of combining the reduced-size vegetable matter, dirt and ash comprises the step of combining 6 parts dirt, 2 parts vegetable matter and a trace of ash.

According to another aspect of the invention, the process includes the step of screening the dirt, vegetable matter and ash combination to mix the combination and remove large debris.

According to another aspect of the invention, a compost product includes vegetable matter selected from the group of vegetable matter consisting of reduced size trees, stumps, brush, leaves and animal manure characterized by an absence of dirt, a variable amount of incinerated vegetable matter to produce a fine ash and the reduced-size vegetable matter and ash combined to produce a compost product.

According to another aspect of the invention, the ash represents a trace amount of compost volume.

According to another aspect of the invention, a topsoil product includes vegetable matter selected from the group of vegetable matter consisting of reduced size trees, stumps, brush, leaves and animal manure, ash and dirt.

According to another aspect of the invention, the topsoil product includes 6 parts dirt, 2 parts vegetable matter and a trace of ash.

### BRIEF DESCRIPTION OF THE DRAWINGS

FIG. 1 is a flow diagram illustrating a process by which vegetable matter, “VM”, is converted to topsoil; and

FIG. 2 is a flow diagram illustrating a process by which vegetable matter, “VM”, is converted to compost.

### DETAILED DESCRIPTION OF PREFERRED EMBODIMENT AND BEST MODE

Referring now to the drawings, in summary, the processes for producing topsoil and compost involves fully incinerating a small amount of the vegetative matter at a very high temperature using an air curtain burner such as disclosed in U.S. Pat. No. 4,739,712. The result of the “air curtain” incineration is a relatively small quantity of fine ash. This ash is mixed with dirt, horse manure and partially-decomposed wood chips and other vegetable matter to form topsoil. The ratios may be on the order of 6 parts dirt, one part manure, one part chips and the ash which may be a trace amount in the neighborhood of 1 percent by volume of the topsoil/compost-mixture. The topsoil product can be easily and efficiently made and can be sold for use, thus saving valuable landfill space. When producing the products, 1 part is equal to 1 bucket, or 3 cubic yards of material. A similar compost product omits the dirt.

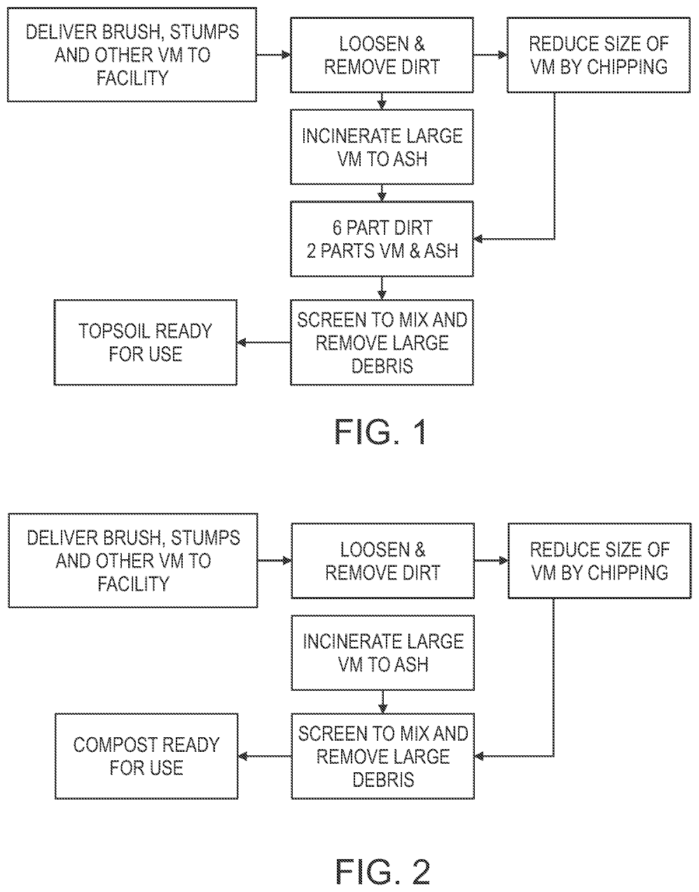

As shown in FIG. 1, brush, stumps, trees, leaves and other organic material are delivered to a processing facility (“Facility”) where a series of processing steps take place. These steps include placing the vegetable matter into a machine that vibrates and tumbles the vegetable matter to loosen dirt, such as may be clinging to the stumps. The dirt is separated from the vegetable matter and pushed into a pile for later use. Some of the remaining vegetable matter after removal of dirt that is too large to be considered dirt is put into an incinerator, for example, an air curtain burner such as disclosed in U.S. Pat. No. 4,739,712, and incinerated. The incineration is highly effective and results in a very small quantity of fine ash. Large-sized vegetable matter is chipped into small-sized pieces and inventoried for partial decomposition. The pieces may be hand to finger sized. Heat naturally generated by the decomposing chips accelerates the decomposition process. For the production of topsoil, 6 parts dirt is mixed with 2 parts mixed vegetable matter such as wood chips, leaves and horse manure and a small amount of the fine ash. This combination of vegetable matter and dirt is screened to mix and remove any large debris not already removed in prior processing. Of the 2 parts, 1 part is preferably the wood chips and/or leaves and 1 part is horse manure. The ash content is a “trace” on the order of 1 percent of the total volume.

Referring to FIG. 2, compost is produced by placing the vegetable matter into a machine that vibrates and tumbles the vegetable matter to loosen dirt, such as may be clinging to the stumps. The dirt is separated from the vegetable matter and pushed into a pile for later use. Some of the remaining vegetable matter, after removal of dirt that is too large to be considered dirt, is incinerated as described above. The incineration is highly effective and results in a very small quantity of fine ash. Large-sized vegetable matter such as trees and stumps is chipped into small-sized pieces and inventoried for partial decomposition. Heat naturally generated by the decomposing chips accelerates the decomposition process.

For the production of compost, wood chips, leaves, horse manure and a small amount of the fine ash are combined. This combination of vegetable matter is screened to mix and remove any large debris not already moved in prior processing. The resulting compost may be allowed to further decompose or may be ready for use.

In both of the processes described above, the leaves, wood chips and horse manure are allowed to sit for predetermined periods of time with the mixture being turned from time-to-time to further integrate the components with each other and further promote decomposition.

The resulting products take full advantage of the biodegradability and combustibility of the vegetable matter resulting in very efficiently produced and highly usable topsoil and compost products. Large amounts of landfill space is conserved, and the products have a market value that can result in revenue to, for example, a municipality instead of significant landfill and transpiration costs. A process for producing topsoil and compost from tree stumps, limbs, brush and similar vegetative matter and the resulting topsoil and compost products according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A process for producing compost, comprising the steps of:
(a) providing a supply of vegetable matter selected from the group of vegetable matter consisting of trees, stumps, brush, leaves and animal manure;
(b) agitating the vegetable matter to loosen and remove dirt associated with the vegetable matter;
(c) reducing the size of the vegetable matter;
(d) incinerating a variable amount of the vegetable matter to produce a fine ash; and
(e) combining the reduced-size vegetable matter and ash.

2. The process according to claim 1, and including the step of screening the combined reduced-size vegetable matter and ash to remove large debris.

3. The process according to claim 1, and including the step of at least partially decomposing the reduced-size vegetable matter.

4. The process according to claim 1, and including the step of at least partially decomposing the reduced-size vegetable matter before combining with the ash.

5. The process according to claim 1, and including the step of reducing the size of the vegetable matter comprises processing the vegetable matter through a chipper.

6. The process according to claim 5, wherein the size of the vegetable matter after chipping ranges between the size of a hand and a finger.

7. A process for producing compost, comprising the steps of:
(a) providing a supply of vegetable matter selected from the group of vegetable matter consisting of trees, stumps, brush, leaves and animal manure;
(b) agitating the vegetable matter to loosen and remove dirt associated with the vegetable matter;
(c) reducing the size of the vegetable matter;
(d) incinerating a variable amount of the vegetable matter to produce a fine ash; and
(e) combining the reduced-size vegetable matter, dirt and ash.

8. The process according to claim 7, and including the step of screening the combined reduced-size vegetable matter and ash to remove large debris.

9. The process according to claim 7, and including the step of at least partially decomposing the reduced-size vegetable matter.

10. The process according to claim 7, and including the step of at least partially decomposing the reduced-size vegetable matter before combining with the ash.

11. The process according to claim 7, and including the step of reducing the size of the vegetable matter comprises processing the vegetable matter through a chipper.

12. The process according to claim 7, wherein the step of combining the reduced-size vegetable matter, dirt and ash comprises the step of combining 6 parts dirt, 2 parts vegetable matter and a trace of ash.

13. The process according to claim 7, and including the step of screening the dirt, vegetable matter and ash combination to mix the combination and remove large debris.
